(19) United States
(12) Patent Application Publication
(10) Pub. No.: US 2009/0315910 A1
(43) Pub. Date: Dec. 24, 2009

(54) SYSTEMS AND METHODS FOR OBTAINING AN IMAGE ALPHA MATTE

(75) Inventors: Chandra KAMBHAMETTU, Newark, DE (US); Yuanjie ZHENG, Newark, DE (US); Karl STEINER, Newark, DE (US); Thomas BAUER, Wilmington, DE (US)

Correspondence Address: RATNERPRESTIA, P.O. BOX 1596, WILMINGTON, DE, 19899, US

(73) Assignees: University of Delaware, Newark, DE (US); Christiana Care Health, Services, Inc., Newark, DE (US)

(21) Appl. No.: 12/487,161

(22) Filed: Jun. 18, 2009

Related U.S. Application Data
(60) Provisional application No. 61/074,221, filed on Jun. 20, 2008.

(51) Int. Cl. G09G 5/02

(52) U.S. Cl. 345/589

(57) ABSTRACT

Methods and systems for obtaining an alpha matte for an image are disclosed. First and second known portions of an image are determined. The alpha matte for the image is estimated based on an initial fuzzy connectedness (FC) determination between the entire image and the first and second known portions. A third known portion is obtained. The estimated alpha matte for the image is refined based on a subsequent FC determination between a subset of the image and the first, second, and third known portions for the subset of the image and the initial FC determination for a remainder of the image.

### CROSS REFERENCE TO RELATED APPLICATIONS

This application is related to and claims the benefit of U.S. Provisional Application No. 61/074,221 entitled SYSTEMS AND METHODS FOR OBTAINING AN IMAGE ALPHA MATTE filed on Jun. 20, 2008, the contents of which are incorporated herein by reference.

### STATEMENT REGARDING FEDERALLY SPONSORED RESEARCH

The present invention was supported in part by a grant from the IDeA Network of Biomedical Research Excellence (INBRE) Program of the National Center for Research Resources (NCRR), a component of the National Institutes of Health (NIH) (Grant No. 2 P20 RR016472-08). The United States Government may have certain rights to the invention.

### FIELD OF THE INVENTION

The present invention relates to the field of image processing and, more particularly, to methods and systems for obtaining an alpha matte for an image.

### BACKGROUND OF THE INVENTION

Image matting, in general, refers to the process of decomposing an observed image into a foreground object image, a background image and an alpha matte. Image matting is typically used to composite the observed image with a new background image, the decomposed foreground image and the alpha matte. For example, a composite image may be formed by combining the decomposed foreground image (or the decomposed background image) with a background (or a foreground) of the other image, by using the decomposed alpha matte. Image matting is widely used in image editing, and in film and video motion picture production, by combining different visual elements from separate sources into a single image.

It is generally difficult to determine the alpha matte from the observed image. Image decomposition is generally under-constrained due to many unknown variables. For example, for each pixel in the observed image, an alpha value (one unknown), foreground color values (three unknowns, for example, red, blue, and green), and background color values (three unknowns, such as red, blue, and green) are used to decompose the observed image. Known values for the observed image include the color (for example, red, blue, and green). Accordingly, to decompose the observed image, there are seven unknown variables and three known variables. To determine the alpha matte of the observed image, constraints, in different forms, are typically included in the image decomposition process. These constraints may be based on some type of user feedback or may be based on the incorporation of more images of the same scene.

### SUMMARY OF THE INVENTION

The present invention is embodied in a method for obtaining an alpha matte for an image. The method determines a first known portion and a second known portion of an image. The method also estimates the alpha matte for the image based on an initial fuzzy connectedness (FC) determination between the entire image and the first and second known portions. The method also obtains a third known portion. The method refines the estimated alpha matte for the image based on a subsequent FC determination between a subset of the image and the first, second, and third known portions for the subset of the image and the initial FC determination for a remainder of the image.

The present invention is also embodied in a system for obtaining an alpha matte for an image. This system includes a controller configured to receive a first known portion, a second known portion, and a third known portion of the image. The system also includes an alpha matte estimator configured to: a) estimate the alpha matte for the image based on an initial FC determination between the entire image and the first and second known portions received from the controller, and b) refine the estimated alpha matte for the image based on a subsequent FC determination between a subset of the image and the first, second and third known portions for the subset of the image and the initial FC determination for a remainder of the image.

### BRIEF DESCRIPTION OF THE DRAWINGS

The invention may be understood from the following detailed description when read in connection with the accompanying drawing. It is emphasized that, according to common practice, various features of the drawing may not be drawn to scale. On the contrary, the dimensions of the various features may be arbitrarily expanded or reduced for clarity. Moreover, in the drawing, common numerical references are used to represent like features. Included in the drawing are the following figures:

FIG. 1 is a functional block diagram illustrating an exemplary system for obtaining an alpha matte for an image, according to an aspect of the present invention;

FIG. 2 is a flow chart illustrating an exemplary method for obtaining an alpha matte for an image, according to an aspect of the present invention;

FIG. 3 is a flow chart illustrating an exemplary method for estimating an initial alpha matte of the image, according to an aspect of the present invention;

FIG. 4 is a flow chart illustrating an exemplary method for refining the initial alpha matte, according to an aspect of the present invention;

FIG. 5 is a flow chart illustrating an exemplary method for compositing a decomposed foreground (or decomposed background) of the image with a further image, according to an aspect of the present invention;

FIG. 6 is an image of a plurality of pixels illustrating an example of FC between two pixels, according to an aspect of the present invention;

FIGS. 7A and 7B are images illustrating an example of FC for pixels with respect to circular stroke on the observed image, according to aspects of the present invention;

FIG. 8 is an image illustrating an exemplary partitioning of a received image into subsets, according to an aspect of the present invention;

FIGS. 9A, 9B, 9C, 9D are images illustrating a performance of an exemplary alpha estimator with the addition of a number of strokes and a resulting composite image in accordance with aspects of the present invention;

FIGS. 10A, 10B, 10C, 10D are images illustrating a performance of various alpha matte estimators including an exemplary alpha matte estimator on an image with the addition of a number of strokes in accordance with aspects of the present invention;

FIGS. 11A, 11B, 11C are images illustrating a performance of an exemplary alpha estimator on a peacock image and a resulting composite image in accordance with aspects of the present invention;

FIGS. 12A, 12B, 12C are images illustrating a performance of an exemplary alpha estimator on a flame image and a resulting composite image in accordance with aspects of the present invention; and

FIGS. 13A and 13B are graphs of estimation errors for various alpha matte estimators including an exemplary alpha matte estimator, based on trimap and stroke selection of portions of the observed image in accordance with aspects of the present invention.

### DETAILED DESCRIPTION OF THE INVENTION

As a general overview, and as will be described in detail below, the present invention is directed to obtaining an alpha matte (a) for an image (I). A first known portion and a second known portion of an image may be determined. Known portions of the image may be indicated by applying strokes to the image or by determining a trimap. As defined herein, each known portion of the image may refer to either a foreground (F) or a background (B) of the image. A general relationship between the foreground, the background and the alpha matte is shown in equation (1) as:

I=αF+(1−α)B. (1)

According to aspects of the present invention, the alpha matte may be estimated for the image based on an initial fuzzy connectedness (FC) determination between pixels of the entire image and the first and second known portions.

Additional strokes represent a third known portion, which may be used to refine the estimated alpha matte. For example, a third known portion may be indicated by one or more further strokes on the image or by a subsequent trimap. As defined herein, the third known portion also refers to the foreground or the background of the image. According to aspects of the present invention, the alpha matte may be refined by determining a subsequent FC between pixels of a subset of the image and the first, second, and third known portions for a subset of the image. The present invention also uses the initial FC determination for a remainder of the image to refine the alpha matte. In this manner, a computational overhead may be reduced when additional inputs are used to refine the estimated alpha matte. It is contemplated that any image, including medical images, may be decomposed according to aspects of the present invention.

The FC determination is based on techniques known in fuzzy medical segmentation, which is typically used to determine a partial volume from multiple tissues in a single image. FC determination, in general, determines an adjacency and/or similarity between pixels of the image. As described herein, the FC at each pixel can be computed by searching for a strongest connected path to a known foreground and background. According to an embodiment of the present invention, FC values may be determined between any two pixels as well as between a pixel and pixels corresponding to each stroke. The alpha matte may then be estimated from the FC, as described further below.

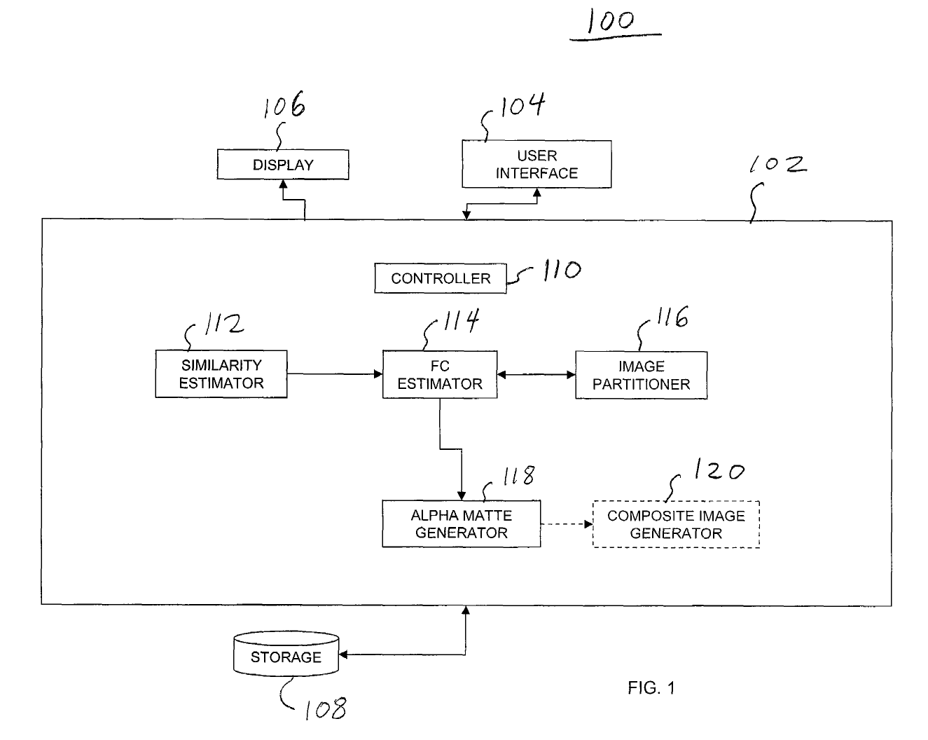

An exemplary system will now described with reference to the individual figures. FIG. 1 is a functional block diagram illustrating an exemplary system 100 for obtaining an alpha matte of an image. System 100 includes alpha matte estimator 102 for estimating the alpha matte of an image, user interface 104, display 106 and storage 108. Suitable user interfaces 104, display 106 and storage 108 will be understood by one of skill in the art from the description herein.

User interface 104 may be used to indicate strokes on an image displayed on display 106. User interface 104 may also be used to indicate a trimap (described below). In addition, user interface 104 may be used to select parameters to decompose the image or to composite the image with an other image. User interface 104 may further be used to select images to be displayed, composited and/or stored. User interface 104 may include a pointing device-type interface for indicating strokes on an image shown on display 104. User interface 104 may further include a text interface for entering information.

Display 106 may be configured to display an image, including strokes indicated by a user responsive to user interface 104. Display 106 may display the estimated alpha matte, a decomposed foreground image (F), a decomposed background image (B), a further image and/or a composited image. It is contemplated that display 106 may include any display capable of presenting information including textual and/or graphical information.

Storage 108 may store the observed image, strokes indicated by the user, a trimap, the initial and subsequent FC determination, the estimated alpha matte, the decomposed foreground image and/or the decomposed background image. Storage 108 may optionally store composited images. Additionally, storage 108 may act as a buffer to temporarily store an image(s) prior to display by display 106. Storage 108 may be a memory, a magnetic disk, a database or essentially any local or remote device capable of storing data.

The illustrated alpha matte estimator 102 includes a controller 110, similarity estimator 112, FC estimator 114, image partitioner 116, and alpha matte generator 118. Alpha matte estimator 102 may also include composite image generator 120. Controller 110 is configured to receive user inputs from user interface 104, such as strokes, and display the user inputs on display 106. Controller 110 is also configured to control similarity estimator 112, FC estimator 114, image partitioner 116, alpha matte generator 118 and composite image generator 120, responsive to user inputs received from user interface 104. Furthermore, controller 110 may also filter the image prior to estimating the alpha matte. Controller 110 may be a conventional digital signal processor.

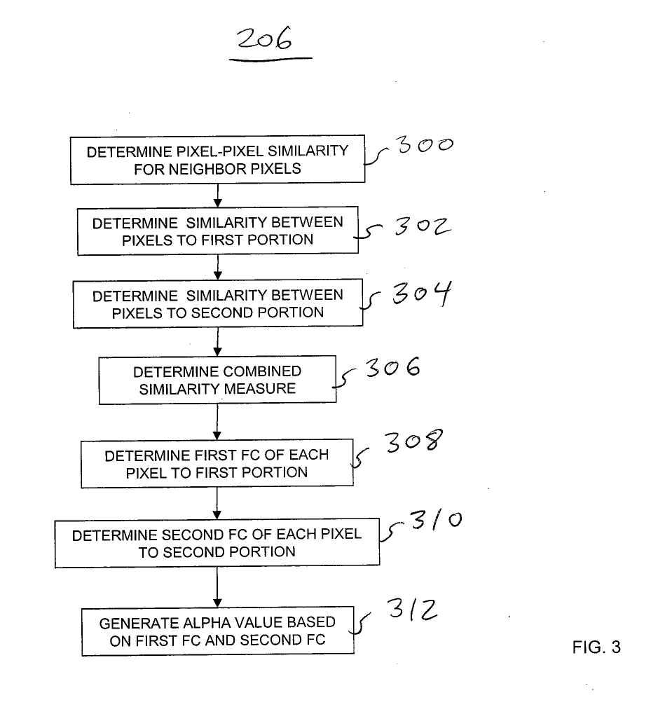

Similarity estimator 112 receives an image that is displayed on display 106 and strokes (e.g., foreground and background strokes) provided from user interface 104. Similarity estimator 112 determines a pixel-pixel similarity between adjacent pixels in the image. In addition, similarity estimator 112 determines a pixel-stroke similarity. The pixel-stroke similarity includes a similarity between pixels to the foreground strokes and a similarity to pixels to the background strokes. The pixel-pixel and pixel-stroke similarities are described further below with respect to FIG. 3. Similarity estimator 112 determines a combined similarity measure (also referred to herein as an affinity) based on the pixel-pixel and pixel-stroke similarities. The combined similarity measure is provided to FC estimator 114. In an alternative embodiment, similarity estimator 112 may determine a trimap from the image displayed on display 106. The trimap may be provided to FC estimator 114.

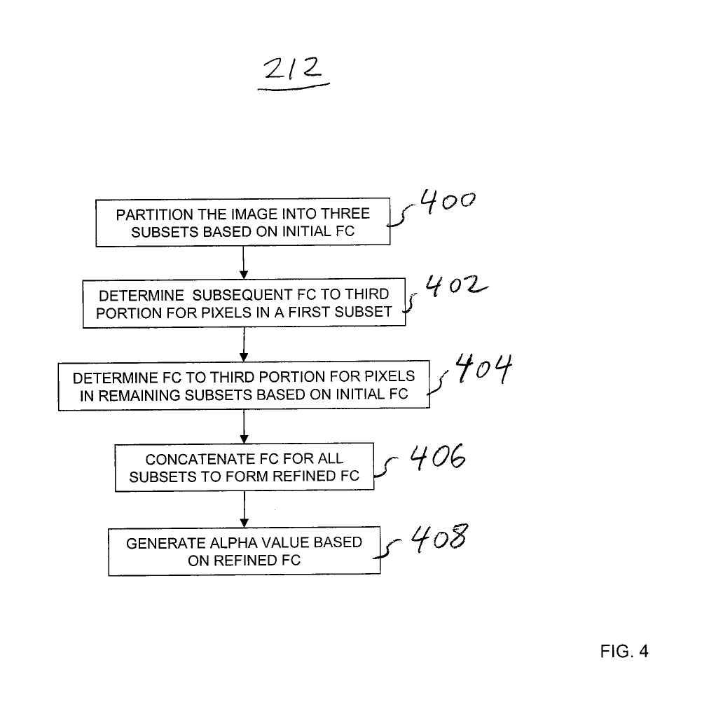

Image partitioner 116 receives an initial FC determination (described further below with respect to FC estimator 114) from FC estimator 114, a further indicated stroke (such as a further background stroke or foreground stroke) from user interface 104, and the image. The initial FC determination is based on the combined similarity measure (or trimap). Image partitioner 116 partitions the image into three subsets based on the initial FC determination and the further stroke, as described below with respect to FIG. 4.

FC estimator 114 receives the combined similarity measure from similarity estimator 112, an image, and the initial strokes, in order to determine the initial FC values for the foreground strokes and the background strokes. The initial FC determination is described further with respect to FIG. 3. FC estimator 114 also receives subsets of the image from image partitioner 116 and the further indicated stroke, in order to determine subsequent FC values for the foreground and background strokes. The subsequent FC determination is described further below with respect to FIG. 4.

Alpha matte generator 118 receives the FC values determined for each pixel, for both foreground and background strokes, from FC estimator 114. Alpha matte generator 118 generates an alpha matte (and a refined alpha matte) for each pixel based on the foreground and background FC values for the corresponding pixel. Alpha matte generation is described further below with respect to FIG. 3.

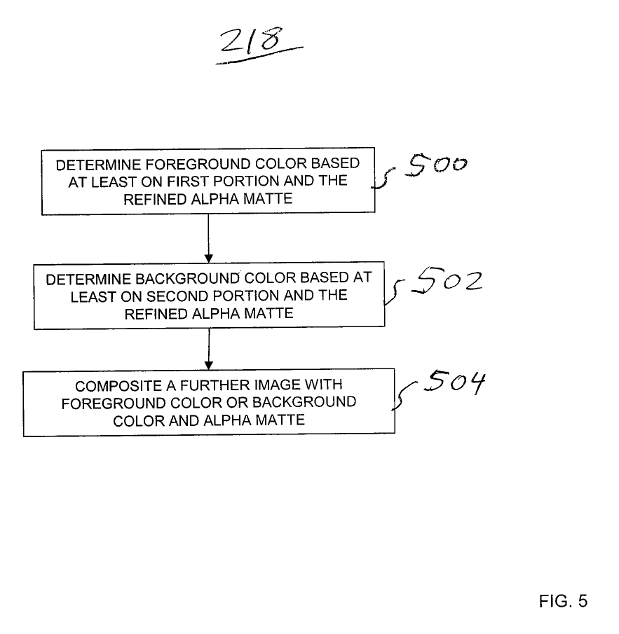

Alpha matte estimator 102 may optionally include composite image generator 120 for generating a composite image based on the estimated alpha matte and the foreground/background strokes with a further image. Alternatively, composite image generator 120 may be provided remote from system 100. The compositing of an image with an other image is described further below with respect to FIG. 5.

It is contemplated that system 100 may be configured to connect to a global information network, e.g., the Internet, (not shown) such that the decomposed image including the refined alpha matte may also be transmitted to a remote location for further processing and/or storage.

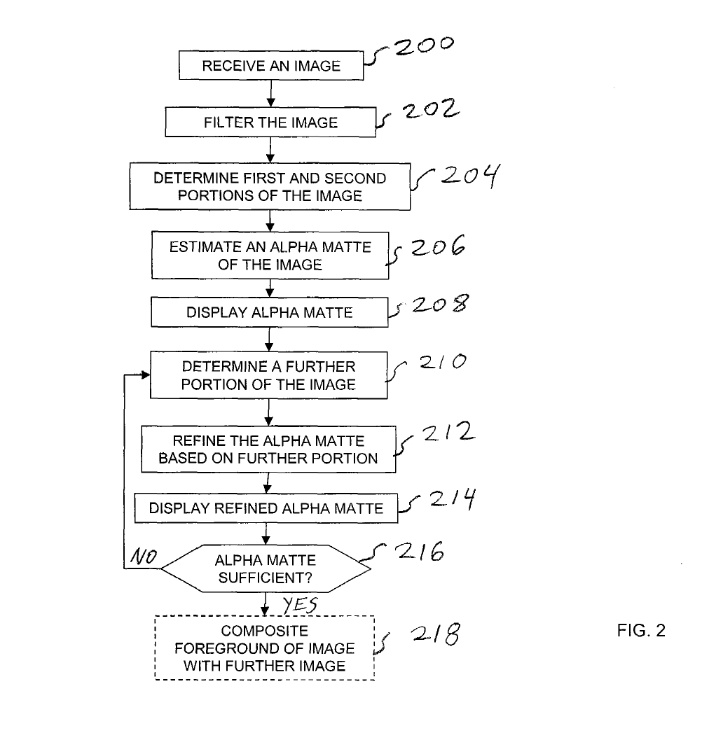

FIG. 2 is a flow chart illustrating an exemplary method for obtaining an alpha matte for an image. In step 200, an image is received, for example, from storage 108 (FIG. 1). In step 202, the image is filtered, for example, by controller 110 (FIG. 1) for display on display 106. In an exemplary embodiment, the image may be preprocessed by bilateral filtering, for example, with variances σ_{d} equal to about 2 or about 5. In general, a filter may be applied to the image in order to smooth the image while preserving edges of the image.

In step 204, first and second portions of the image are determined. For example, strokes representing the foreground and the background may be indicated via user interface 104 (FIG. 1) on the image displayed by display 106. As defined herein, each stroke selects a number of pixels on the displayed image to indicate the foreground or background. Values of the selected pixels in the stroke may be used to determine the foreground or background. For example, referring to FIG. 9B, an initial background stroke 902 and an initial foreground stroke 904 are shown.

Referring back to FIG. 2, in step 206, an alpha matte of the image is estimated. For example, similarity estimator 112, FC estimator 114, and alpha matte generator 118, responsive to controller 110, may be used to estimate the alpha matte (FIG. 1). In step 208, the alpha matte is displayed, for example, by display 106 (FIG. 1).

In step 210, an additional portion of the image is determined. For example, an additional stroke is indicated via user interface 104 (FIG. 1). In step 212, the alpha matte is refined based on the further portion indicated, for example, by a further stroke on the image. For example, image partitioner 116, FC estimator 114 and alpha matte generator 118, responsive to controller 110, may be used to refine the alpha matte (FIG. 1). In step 214, the refined alpha matte is displayed, for example, by display 106 (FIG. 1).

In step 216, it is determined whether the alpha matte is sufficiently estimated. If the alpha matte is sufficiently estimated, step 216 proceeds to optional step 218. If the alpha matte is not sufficiently estimated, step 216 proceeds to step 210 and processing continues with steps 210, 212, 214 and 216 until the alpha matte is sufficiently estimated.

In optional step 218, the decomposed foreground image may be composited with a background of a further image, for example, by composite image generator 120 (FIG. 1). Alternatively, the decomposed background image may be composited with a foreground of a further image. It is understood that the process may be complete without performing optional step 218.

FIG. 3 is a flow chart illustrating an exemplary method for estimating the alpha matte of the image, step 206 in FIG. 2, based on the first and second determined portions of the image. In step 300, the pixel-pixel similarity (μ_{ψ}⁰) is determined for neighbor pixels. The superscript o represents foreground stroke (f) or background stroke (b). In step 302, a pixel-stroke similarity (ψ_{φ}⁰) is determined between pixels of the image to the first determined portion (i.e., a foreground stroke). The pixel-stroke similarity measures the color similarity between two pixels (P₁, P₂).

In an exemplary embodiment, a Gaussian mixture model (GMM) is used to fit both the foreground stroke colors and background stroke colors. A GMM is used for both the pixel-pixel similarity and the pixel-stroke similarity. In an exemplary embodiment, an International Commission on Illumination 1976 L*u*v*(CIE LUV) color representation is used. CIE LUV is well known to those of skill in the art of image processing. In addition, for each Gaussian in the corresponding GMM, a variance of all three channels (e.g., red, green and blue) is averaged.

The pixel-pixel similarity is shown in equation (2) as:

$${μ}_{ψ}^{o} ( {p}_{1} , {p}_{2} ) = exp ( - {\frac{1}{2} [ I ( {p}_{1} ) - I ( {p}_{2} ) ]}^{T} {( {\sum }_{max}^{o} )}^{- 1} [ I ( {p}_{1} ) - I ( {p}_{2} ) ] ) , \\ o ∈ \{ f , b \} \qquad ( 2 )$$

where p₁ and p₂ represents pixels, T represents a transpose operation and

$${\sum }_{max}^{o}$$

represents a covariance matrix of a Gaussian that has a largest average variance. By selecting a largest average variance, a robustness of FC determination may be robust in highly textured regions.

In step 304, a pixel-stroke similarity is determined between pixels to a second determined portion of the image (i.e., a background stroke). The pixel-stroke similarity measures the color similarity between p₁ and p₂ and the color of strokes in o and takes a high value when p₁ and p₂ are both close to the color of the stroke.

A similarity metric S^{f}(p) between a color of a pixel (p) to the foreground stroke color is defined in equation (3) as:

$${S}^{f} ( p ) = {max}_{i} exp ( - {\frac{1}{2} [ I ( p ) - {m}_{i}^{f} ]}^{T} {( {\sum }_{i}^{f} )}^{- 1} [ I ( p ) - {m}_{i}^{f} ] ) \qquad ( 3 )$$

where i is an index of the Gaussian in the GMM of the foreground color, and mᵢ^{f},

$${\sum }_{i}^{f}$$

are the mean vector and covariance matrix, respectively, of the corresponding number Gaussian. A similarity metric S^{b}(p) between a color of a pixel (p) to the background stroke color can be similarly determined.

The pixel-stroke similarity for the foreground stroke (f) is determined using the similarity metric (equation 3) as:

$${μ}_{φ}^{f} ( {p}_{1} , {p}_{2} ) = \{ \begin{matrix}1 & if {p}_{1} = {p}_{2} \\ \frac{{W}_{min}^{f} ( {p}_{1} , {p}_{2} )}{{W}_{min}^{f} ( {p}_{1} , {p}_{2} ) + {W}_{max}^{f} ( {p}_{1} , {p}_{2} )} & if {W}_{min}^{f} ( {p}_{1} , {p}_{2} ) \neq 0 \\ 0 & otherwise\end{matrix} \qquad ( 4 )$$

where

Wₘᵢₙ^{f}(p₁, p₂)=min[S^{f}(p₁), S^{f}(p₂)]

and

Wₘₐₓ^{f}(p₁, p₂)=max[S^{f}(p₁), S^{f}(p₂)]

Although not show, the pixel-stroke similarity for the background stroke (b) can be similarly determined.

In step 306, a combined similarity measure (i.e., the affinity measure) is determined from the combination of the pixel-pixel similarity and pixel-stroke similarity measures. Steps 300-306 may be performed by similarity estimator 112 (FIG. 1).

The combined similarity measure (i.e. affinity A) is defined by equation (5) as:

A⁰(p₁, p₂)=λμ_{ψ}⁰ (p₁, p₂)+(1−λ)μ_{φ}⁰(p₁,p₂) o ε{f,b} (5)

where λ is used to balance the pixel-pixel and pixel-stroke similarity measures and is between zero and one. The combined similarity measure shown in equation (5) extends the affinity between pixels to color images, and extends the known pixels to foreground and background strokes.

In step 308, a first FC value of each pixel to the first portion (e.g., the foreground stroke) is determined. In step 310, a second FC of each pixel to the second portion (e.g., the background stroke) is determined. Steps 308 and 310 may be performed, for example, by FC estimator 114 (FIG. 1).

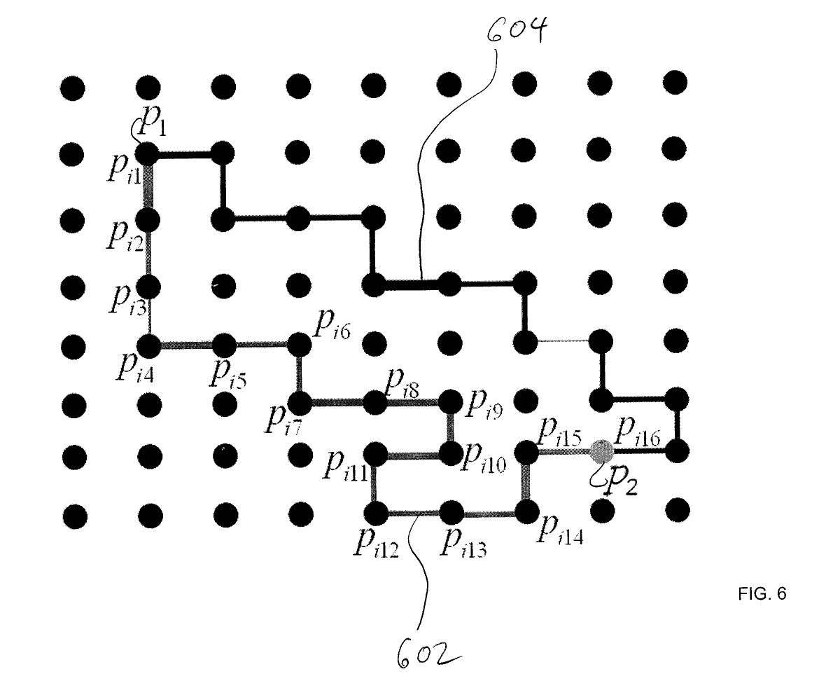

Referring to FIG. 6, the FC between two pixels p₁ and p₂ is described. To define the FC between two pixels p₁ and p₂, a path γ may be represented between pixels p₁ and p₂ in the image Ω as a sequence of n_{γ} pixels {q₁, q₂, . . . , q_{nγ}} where q₁=p₁i, q_{nγ}=p2, and pₖ and pₖ₊₁ are the two neighboring pixels in Ω, as shown in FIG. 6. In FIG. 6, path 604 represents a stronger path whereas path 602 represents a weaker path. The strength of path γ may be defined as:

$${str}^{o} ( γ ( {p}_{1} \to {p}_{2} ) ) = {min}_{j = 2 … , {n}_{γ}} {A}^{o} ( {q}_{j - 1} , {q}_{j} ) , for o ∈ \{ f , b \} . \qquad ( 6 )$$

Then, the FC between p1 and p2 may be defined as:

$${FC}^{o} ( {p}_{1} , {p}_{2} ) = {max}_{all γ} {str}^{o} ( γ ) , for o ∈ \{ f , b \} \qquad ( 7 )$$

where FC^{f} and FC^{b} represent the FC with respect to the foreground and background strokes.

The min and max metrics in respective equations (6) and (7) substantially guarantee that the FC between two pixels inside the same region of the same object is large. Furthermore, a path exists along which the color changes smoothly. Accordingly, even if the pixel intensities are different, for example, due to a graded composition of a heterogeneous material of the object, the FC values for the original received image may still be large.

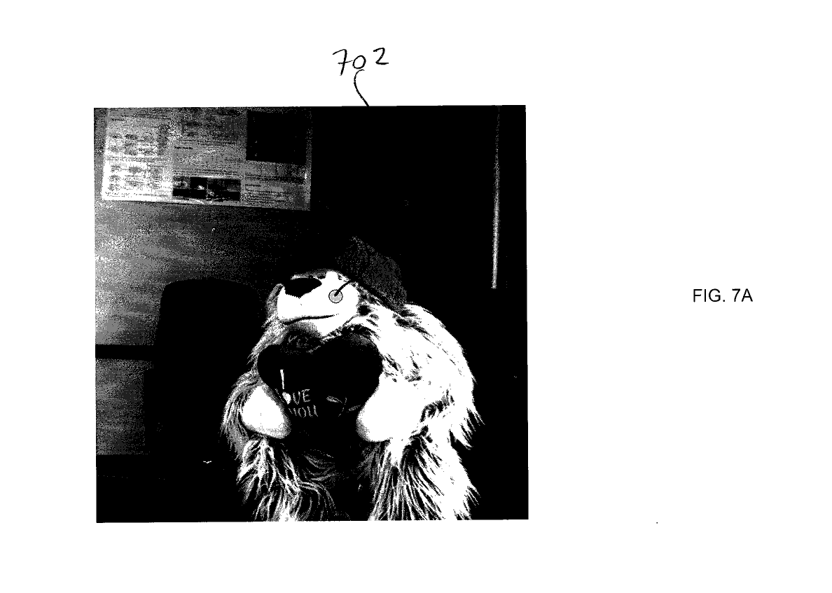

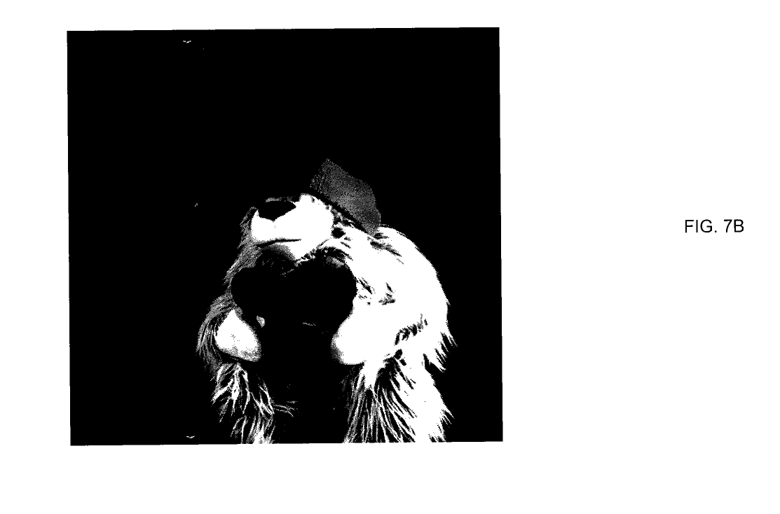

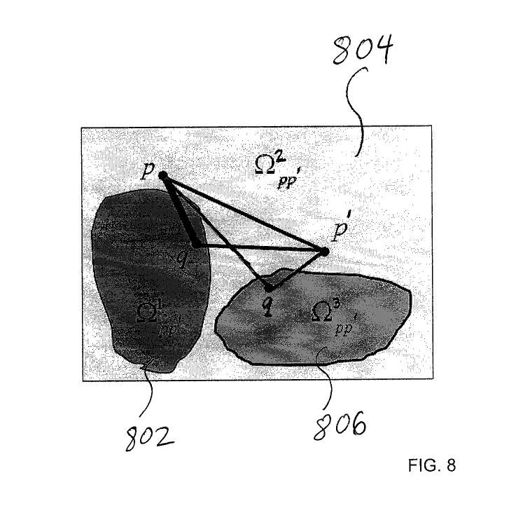

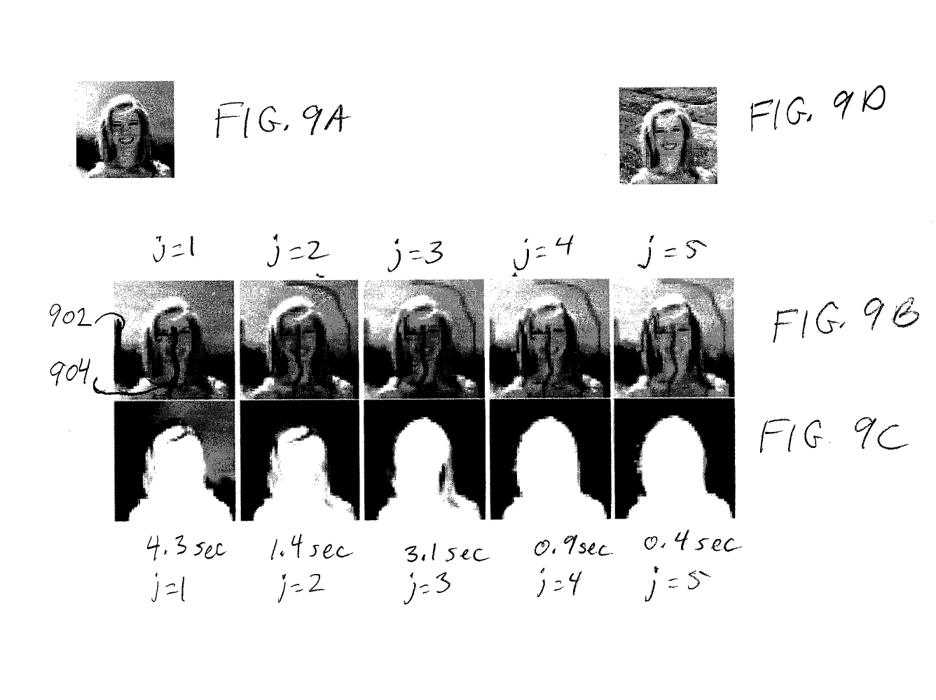

Referring back to FIG. 3, a FC between pixel p and a) the foreground strokes FC^{f}(p) and b) background strokes FC^{b}(p) may be defined as:

$${FC}^{o} ( p ) = FC ( {Ω}^{o} , p ) = {max}_{{p}^{′} ∈ {Ω}^{o}} {FC}^{o} ( {p}^{′} , p ) , o ∈ \{ f , b \} \qquad ( 8 )$$

where f and b represent the foreground and the background strokes, respectively. Referring to FIGS. 7A and 7B, images are shown illustrating an example of FC for pixels with respect to a circular stroke 702 on the observed image. In FIG. 7A, an original image with circular stroke 702 is shown. In FIG. 7B, the FC values for all pixels are represented with respect to the circular stroke 702 indicated on the original image shown in FIG. 7A.

Referring back to FIG. 3, a further FC between two sets of pixels P and Q can be defined using pixel-pixel FC equation (7) as:

$$FC ( P , Q ) = {max}_{p ∈ P} {max}_{q ∈ Q} FC ( p , q ) . \qquad ( 9 )$$

Equation (9) may be used to determine a maximum value of pixel-to-pixel FC values.

In step 312, an alpha value for each pixel is determined based on the first and second FC values FC^{f}(p), FC^{b}(p), for example, by alpha matte generator 118 (FIG. 1). The FC between pixels is related to the matting problem. A pixel with larger alpha values may be more closely correlated to the foreground strokes and, thus, have a larger FC value to the foreground as compared with the background. Similarly, a pixel with smaller alpha values may be more closely correlated to the background strokes and, thus have a larger FC value to the background. Therefore, the alpha matte (α) for each pixel may be determined using the corresponding foreground and background FC values as:

$$α ( p ) = \{ \begin{matrix}1 & ( {FC}^{f} ( p ) > {v}_{1} ) \& ( {FC}^{b} ( p ) < {v}_{2} ) \\ 0 & ( {FC}^{b} ( p ) > {v}_{1} ) \& ( {FC}^{f} ( p ) < {v}_{2} ) \\ \frac{{FC}^{f} ( p )}{{FC}^{f} ( p ) + {FC}^{b} ( p )} & otherwise\end{matrix} \qquad ( 10 )$$

In an exemplary embodiment, thresholds of v₁ of about 0.95 and v₂ of about 0.05 are used to determine if each pixel p represents a foreground (i.e., α=1), a background (i.e., α=0), or is transparent (i.e., α is a function of the ratio of the foreground and background FC values).

In an exemplary embodiment, efficient algorithms may be used to compute, for pixels with unknown alpha, their FC to the foreground and the background strokes. The computed FC can then directly be used to evaluate the alpha matte with equation (10).

Computing the FC between two pixels is, in general, a single-source shortest path problem. The only difference is that the cost of each path may be considered to be a minimal affinity between all neighboring pixels in the FC computation. In an exemplary embodiment, Dijkstra's algorithm may be used to compute the FC values. The running time of the algorithm may be further improved by using a Fibonacci heap. In addition, because Dijkstra's algorithm computes a shortest path from a single node to all nodes, the FC from each pixel to the strokes may be determined using the algorithm. Dijkstra's algorithm and the Fibonacci heap are well known to those of skill in the art of image processing.

It is desirable to reduce computational overhead when further strokes are added to the image. If a further stroke introduces new colors in the GMM, changes may occur to: i) the affinity between neighboring pixels, and ii) the FC value that is based on the strongest path from the pixel to the foreground and background strokes.

For the affinity measure (equation 5), a computational cost is incurred to calculate the pixel-pixel similarity (equation 2) and pixel-stroke similarity (equation 4). To minimize this cost, the strokes can be indicated to cover most of the main colors of foreground or background in the first iteration so that the cost for updating affinity will be kept minimal when new strokes are added. As described below with respect to FIG. 4, to recompute the FC, the pixels may be partitioned into three subsets. Only in one subset of pixels is the FC re-estimated, by searching for the strongest path within a smaller domain. The other two subsets may directly update their FC values based on the previously computed FC.

FIG. 4 is flow chart illustrating an exemplary method for refining the alpha matte, step 212 in FIG. 2, based on a further portion indicated, for example, a third stroke. In step 400, the image is partitioned into three subsets based on the initially determined FC values and the third stroke, for example by image partitioner 116 (FIG. 1). In step 402, subsequent FC values are determined for the third portion for pixels in a first subset. In step 404, FC values are determined to the third portion for pixels in remaining subsets based on the initially determined FC values.

Referring to FIG. 8, an image may be partitioned into three subsets 802, 804, 806. The dots in FIG. 8 denote pixels and thicker lines connecting the two pixels corresponds to larger values of FC between the pixels. Assuming that the FC values to a pixel have been computed to all pixels in the image Ω, given a different pixel p′, the image Ω can be portioned into three subsets Ω¹_{pp′} (802), Ω²_{pp′} (804) and Ω³_{pp′} (806) such that:

∀q ε Ω¹_{pp′}, FC(p, q)>FC(p, p′)

∀q ε Ω²_{pp′}, FC(p, q)=FC(p, p′)

∀q ε Ω³_{pp′}, FC(p, q)<FC(p, p′)

The above relationships represent the computation of pixel-pixel FC. The relationships imply that once the initial FC values from each pixel to one pixel p are obtained, to compute the FC value of all pixels to a new pixel p′, only pixels in subset 804 may recompute the FC using the strongest path search. The remaining pixels in regions 802 and 806 may simply reuse the previously computed FC. Furthermore, the FC for a pixel in q in the set of region 804 is either equal to FC(p,p′) or the strongest path for computing the FC is in the domain region 804.

In an exemplary embodiment, the FC values of pixels in domain 804 may be initialized as FC(p, p′), and a Dijkstra-FC-T algorithm may be used to search for the strongest path within the constrained domain of 804, rather than the entire image. This approach may substantially reduce the computation cost associated with refining the alpha matte.

The results of pixel-pixel FC determination may be extended to pixel-stroke FC determination. Given a new stroke that covers a set of pixels P′, the image Q may be partitioned into three subsets Ω¹_{pp′}, Ω²_{pp′} and Ω¹_{pp′} such that:

∀q ε Ω¹_{pp′}, FC(p, q)>FC(p, p′)

∀q ε Ω²_{pp′}, FC(p, q)=FC(p, p′)

∀q ε Ω³_{pp′}, FC(p, q)<FC(p, p′)

The above relationships illustrates that, given the FC values of all pixels to some stroke pixels P, to compute the FC values of all pixels to the newly added stroke pixels P′, the strongest path for pixels in regions 802 and 806 do not need to be recalculated. Instead, the FC values in regions 802, 806 may be determined directly from the initially determined FC to stroke pixels P. For the remaining pixels in region 804 where the strongest path is recomputed, the search domain is within region 804.

In an exemplary embodiment, to compute the FC values for pixels in region 804 to the newly added stroke, the FC values of pixels in the new stroke are initialized to about 1, and template values in each subset are set to about 0. The Dijkstra-FC-T algorithm is used to determine the subsequent FC values to region 804 as well as the FC values to regions 802 and 806 that rely on the initial FC values.

Referring back to FIG. 4, in step 406, the FC values determined for each subset are concatenated to form refined FC values for the image. Steps 402-406 may be processed, for example, by FC estimator 114.

In step 408, alpha values for an alpha matte are generated based on the refined FC, for example, by alpha matte generator 118 (FIG. 1), and described above with respect to FIG. 3.

FIG. 5 is a flow chart illustrating an exemplary method for compositing the decomposed foreground of an image with a further image, step 218 in FIG. 2. Alternatively, the decomposed background of an image may be composited with a foreground of a further image.

In step 500, a foreground color is determined based at least on a first determined portion (i.e., a first foreground stroke) and the refined alpha matte. In step 502, a background color is determined based at least on the second portion (the initial background stroke) and the refined alpha matte. In step 504, the background of a further image is composited with the foreground color using the refined alpha matte.

To determine the foreground and background colors, a GMM is fitted to represent both the foreground and background colors of the pixels whose FC exceeds the thresholds (v₁,v₂). An optimal pair of foreground and background colors are determined that minimize a fitting error based on equation (10).

The present invention is illustrated by reference to a number of examples. The examples are included to more clearly demonstrate the overall nature of the invention. These examples are exemplary, and not restrictive of the invention.

### EXAMPLES

FIGS. 9A, 9B, 9C, 9D are images illustrating a performance of an exemplary alpha estimator with the addition of a number of strokes and a resulting composite image. In particular, FIG. 9A is an original image; FIG. 9B are a series of images of the original image shown in FIG. 9A with the indication of strokes added to the original images; FIG. 9C is a series of alpha mattes estimated based on the corresponding indicated strokes; and FIG. 9D is a composite image formed using the foreground of the original image shown in FIG. 9A.

The images shown in FIGS. 9A-9D illustrate the use of an exemplary alpha matte estimator. In FIG. 9B, iterations for adding strokes to the original image shown in FIG. 9A are indicated by j, with j=1 being the initial strokes added to the original image and j greater than 1 representing iterations where additional strokes are added to the original image. As new strokes are gradually added, the corresponding alpha matte shows an improvement. A run time, illustrated below FIG. 9C, between each iteration also significantly decreases. The only exception is at a third iteration where the computation time increases. The computation time in this case may increase because the newly added strokes at the third iteration may introduce new foreground colors. Because of the new foreground colors, the affinity values may be recomputed and the FC values may further be recomputed for each subset.

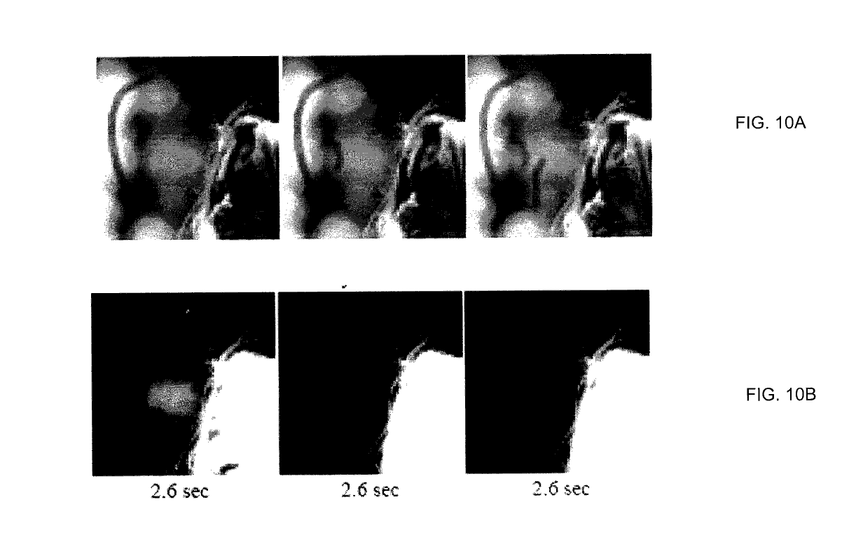

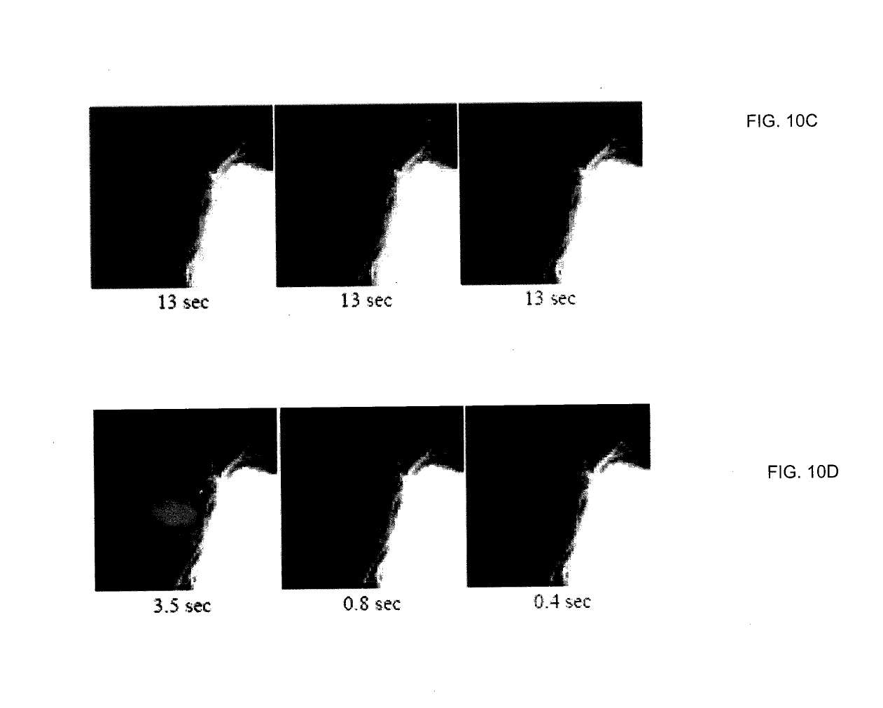

FIGS. 10A, 10B, 10C, 10D are images illustrating a performance of various alpha matte estimators including an exemplary alpha matte estimator on an image with the addition of a number of strokes, including their respective run times. In particular, FIG. 10A represents interactively drawn strokes on an original image; FIG. 10B represents an interactive belief propagation (BP) matting estimator; FIG. 10C represents a spectral matting estimator; and FIG. 10D represents an exemplary alpha matte estimator.

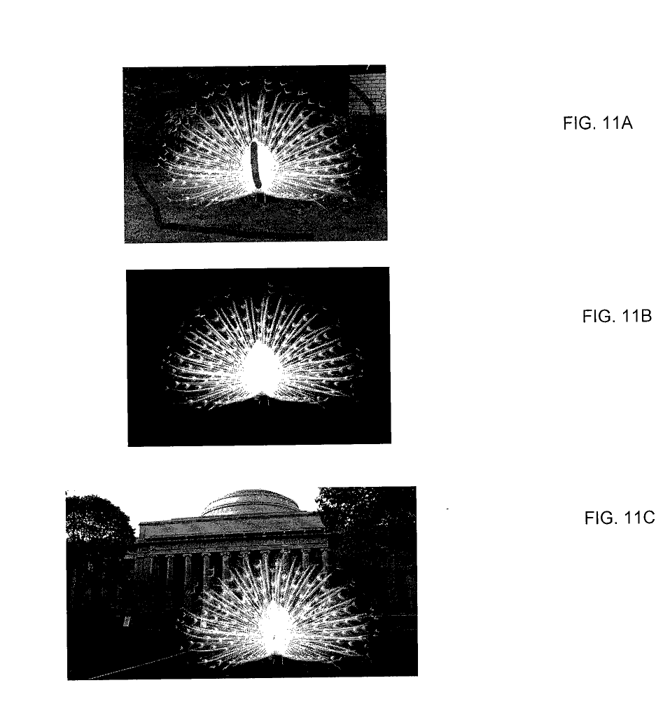

In FIGS. 10A-10D, an exemplary alpha matte estimator is compared with other approaches including interactive BP and spectral matting. In FIGS. 10A-10D, spectral matting was implemented in MATLAB®, available from The MathWorks, Inc., of Natick, Mass., USA, and interactive BP was implemented in C++. For spectral matting, the computation of the spectral components is considered to be preprocessing and are not included in the final processing time at each iteration. An exemplary alpha matte estimation is implemented in C++ and for all of the examples, except for the peacock image (FIGS. 11A-11C), λ is set to about 0.7 (equation 5). In the examples, all algorithms were run on a 2.39 GHz personal computer (PC).

In FIGS. 10A-10D, the run time for each iteration may be compared across the different estimators. Although it may be generally difficult to compare these algorithms (some implemented in MATLAB® and some in C++), it may be seen that the run time of the exemplary alpha matte estimator (FIG. 10D) is significantly reduced at each iteration of stroke refinement. For the remaining estimators (FIGS. 10B and 10C) the run times are constant regardless of the refinement with additional strokes.

If the exemplary alpha matte estimator (FIG. 10D) is compared with interactive BP (FIG. 10B) (both being implemented in C++), it is seen that the processing time of the first iteration is approximately the same. However, at subsequent iterations, as more strokes are added, the exemplary alpha matte estimator (FIG. 10D) re-estimates the alpha matte faster than interactive BP (FIG. 10B).

Because the exemplary alpha matte estimator only re-computes the FC values for a small subset of the pixels, the processing time may be reduced with the addition of subsequent strokes. For example, the last iteration shown in FIG. 10D updates 9.6% of all pixels. This refinement capability makes the exemplary alpha matte estimator a highly useful tool for interactive matting, particularly at the later stage of interactive refinements, when many small strokes may be added to recover fine details about the foreground and/or background.

Each estimator shown in FIGS. 10B-10D may produce a high-quality alpha matte with a sufficient number of strokes. However, each estimator may improve the alpha matte in different ways at each iteration of refinement. For example, spectral matting (FIG. 10C) may generate high-quality alpha mattes for pixels near the foreground with two simple strokes (FIG. 10A). However, the errors in background may not be substantially improved with additional strokes. The exemplary alpha matte estimator (FIG. 10D) and interactive BP (FIG. 10B) may significantly improve the quality of the alpha matte near the background with additional strokes.

Furthermore, interactive BP (FIG. 10B) and spectral matting (FIG. 10C) may both generate large errors for pixels in the foreground that have similar colors to the background (e.g., black regions near the “forehead” of the matte images in FIG. 10A). The exemplary alpha matte estimator (FIG. 10D), in contrast, does not generate these large errors. For the exemplary alpha matte estimator, if a pixel's surrounding neighbors all have high FC values to the strokes, the pixel itself has a high probability of having a high FC because of the high pixel-pixel similarity (equation 2). An exception may occur when the color difference between the pixel and the strokes is large, i.e., the pixel-stroke similarity is low (equation 4). The exemplary alpha matte estimator balances the two terms by setting an appropriate λ when computing the affinity (equation 5).

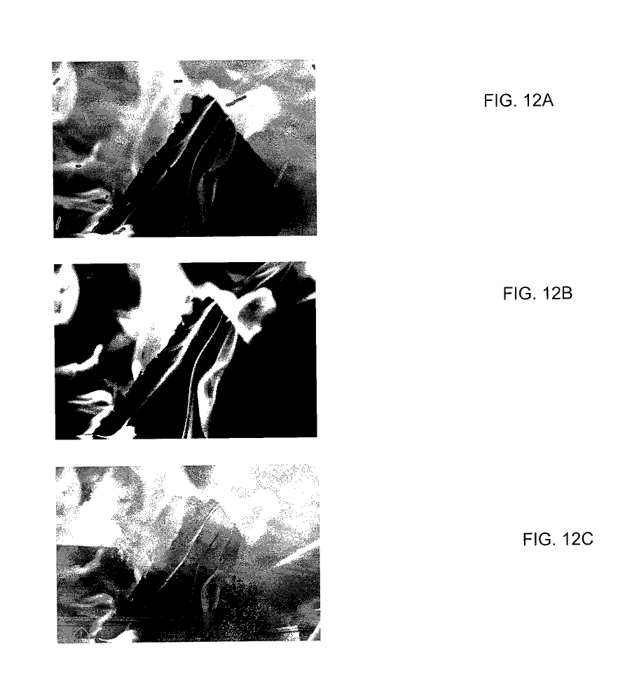

Referring generally to FIGS. 11 and 12, performance of an exemplary alpha matte estimator on complex images is shown. In particular, FIGS. 11A, 11B, 11C are images illustrating a performance of an exemplary alpha estimator on a peacock image and a resulting composite image; and FIGS. 12A, 12B, 12C are images illustrating a performance of an exemplary alpha estimator on a flame image and a resulting composite image. FIGS. 11A, 12A are respective peacock and flame images with foreground and background strokes; FIGS. 11B, 12B are corresponding alpha mattes estimated by an exemplary alpha matte estimator; and FIGS. 11C, 12C are composite images formed from the foregrounds extracted from respective original images 11A, 11B.

For the peacock image (FIG. 11A), about three strokes are used at a first iteration, one on the foreground and two on the background. The variable λ is set to about 0.5 (equation 5) for computing the affinity. A processing time for the initial alpha matte estimation was about 4 seconds. Because the peacock includes fine details at its tail, a total of around seven additional strokes near the tail and the feet was added over about three iterations. The computational cost at each iteration was about 0.5 second, much faster than many conventional matting methods. For the flame image (FIG. 12A), the flame image used a gradual refinement with a number of small strokes to generate a satisfactory alpha matte.

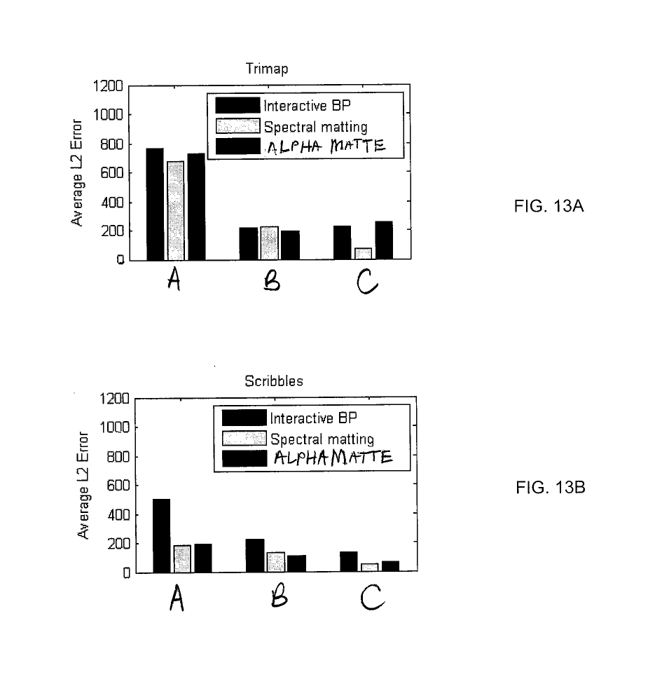

FIGS. 13A, 13B are graphs of estimation errors for various alpha matte estimators including an exemplary alpha matte estimator, based on trimap (FIG. 13A) and stroke/scribble selection (FIG. 13B) of portions of three different observed images (designated as A, B, C). In FIGS. 13A, 13B, an exemplary alpha matte estimator is compared with interactive BP matting and spectral matting including average sum of squared differences (SSD) errors. The SSD error, in general, determines an error with respect to ground truth for BP matting, spectral matting and the exemplary alpha matte estimator. SSD and ground truth are well known to those of skill in the art of image processing. In general an exemplary alpha matte estimator generates accurate matting results comparable to spectral matting.

Although the invention has been described in terms of systems and methods for obtaining an alpha matte for an image, it is contemplated that one or more steps and/or components may be implemented in software for use with microprocessors/general purpose computers (not shown). In this embodiment, one or more of the functions of the various components and/or steps described above may be implemented in software that controls a computer. The software may be embodied in tangible computer readable media for execution by the computer.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for obtaining an alpha matte for an image, the method comprising:
determining a first known portion and a second known portion of an image;
estimating the alpha matte for the image based on an initial fuzzy connectedness (FC) determination between the entire image and the first and second known portions;
obtaining a third known portion; and
refining the estimated alpha matte for the image based on a subsequent FC determination between a subset of the image and the first, second, and third known portions for the subset of the image and the initial FC determination for a remainder of the image.

2. The method according to claim 1, wherein the determining of the first known portion and the second known portion includes:
generating a trimap from the image, and estimating the first and second known portions from the generated trimap.

3. The method according to claim 1, wherein the image includes a medical image.

4. The method according to claim 1, the method including:
bilateral filtering the image, prior to determining the first and second known portions.

5. The method according to claim 1, further including:
obtaining at least one subsequent third portion; and
repeating the step of refining the estimated alpha matte based on the subsequent third portion.

6. The method according to claim 1, further including:
storing at least one of the first known portion, the second known portion, the third known portion, the estimated alpha matte, the refined alpha matte, the initial FC determination, the subsequent FC determination, or the image.

7. A computer readable medium, including a program configured to cause a computer to execute the method according to claim 1.

8. The method according to claim 1, wherein the refining of the estimated alpha matte includes:
determining a first connected path between pixels in the subset of the image and the third known portion to form the subsequent FC determination;
determining a second connected path between pixels in the remainder of the image and the third known portion based on the initial FC determination to form a further FC; and
concatenating the subsequent FC determination and the further FC to form a refined FC,
wherein the refined alpha matte is determined based on the refined FC, and
wherein the first and second connected paths are determined based on at least one of a pixel similarity or a pixel adjacency.

9. The method according to claim 1, further including:
determining a foreground color and a background color of the image based on the refined alpha matte, the first known portion, the second known portion and the third known portion.

10. The method according to claim 9, further including:
compositing one of the foreground color and the background color with an other image using the refined alpha matte.

11. The method according to claim 1, wherein the determining of the first and second known portions includes:
indicating first and second strokes on the image corresponding to the first and second known portions, respectively.

12. The method according to claim 11, wherein the obtaining of the third known portion includes:
indicating a third stroke on the image corresponding to the third known region.

13. The method according to claim 12, further including, prior to refining the estimated alpha matte:
partitioning the image into the subset based on the initial FC determination between pixels in the image to the third stroke.

14. The method according to claim 13, wherein the remainder of the image is partitioned into first and second regions based on the initial FC determination between the pixels in the image to the third stroke.

15. The method according to claim 11, wherein the estimating of the alpha matte includes:
determining a first connected path between each of the pixels of the image and the first stroke to form a first FC; and
determining a second connected path between each of the pixels of the image and the second stroke to form a second FC,
wherein each of the first and second connected paths being determined based on at least one of a pixel similarity or a pixel adjacency, and
wherein the first FC and the second FC form the initial FC determination.

16. The method according to claim 15, the method further including:
setting the alpha matte to a first value when the first FC is a maximum value and the second FC is a minimum value;
setting the alpha matte to a second value when the first FC is a minimum value and the second FC is a maximum value; and
setting the alpha matte to a ratio of the first FC and the second FC otherwise.

17. The method according to claim 11, prior to estimating the alpha matte, further including:
determining a first similarity between pixels of the image;
determining a second similarity between the pixels of the image to each of the first and second strokes; and
combining the first similarity and the second similarity to form a combined similarity measure,
wherein the initial FC determination is based on the combined similarity measure.

18. The method according to claim 17, the method further including:
fitting a first Gaussian mixture model (GMM) to pixels of the image corresponding to the first stroke; and
fitting a second GMM to pixels of the image corresponding to the second stroke,
wherein each of the first similarity and the second similarity are determined based on the first GMM and the second GMM.

19. The method according to claim 17, wherein each of the first similarity and the second similarity are determined using a similarity in color between the respective pixels.

20. A system for obtaining an alpha matte for an image, the system comprising:
a controller configured to receive a first known portion, a second known portion, and a third known portion of the image; and
an alpha matte estimator configured to a) estimate the alpha matte for the image based on an initial fuzzy connectedness (FC) determination between the entire image and the first and second known portions received from the controller and b) refine the estimated alpha matte for the image based on a subsequent FC determination between a subset of the image and the first, second, and third known portions for the subset of the image and the initial FC determination for a remainder of the image.

21. The system according to claim 20, wherein the alpha matte estimator includes:
an FC estimator configured to estimate the initial FC determination and the subsequent FC determination; and
an alpha matte generator configured to a) estimate the alpha matte based on the initial FC determination received from the FC estimator and b) refine the alpha matte based on the subsequent FC determination received from the FC estimator.

22. The system according to claim 20, further comprising:
a display configured to display the image; and
a user interface configured to indicate the first known portion, the second known portion and the third known portion of the image.

23. The system according to claim 22, wherein the first, second and third known portions are indicated by respective first, second and third strokes on the image via the display and the user interface.

24. The system according to claim 22, wherein the alpha matte estimator includes:
a similarity estimator configured to a) determine a first similarity between pixels of the image, b) determine a second similarity between the pixels of the image to each of the first and second strokes, respectively and c) combine the first similarity and the second similarity to form a combined similarity measure,
wherein the initial FC determination is based on the combined similarity measure.

25. The system according to claim 23, wherein the alpha matte estimator further includes an image partitioner configured to partition the image into the subset based on the initial FC determination between pixels in the image to the third stroke.
